(19) United States
(12) Patent Application Publication
(10) Pub. No.: US 2002/0098366 A1
(43) Pub. Date: Jul. 25, 2002

(54) Methods of forming anti-corrosion coatings and articles formed thereby

(76) Inventors: Hua Guo, Selkirk, NY (US); Kenneth Paul Zarnoch, Scotia, NY (US)

Correspondence Address: CANTOR COLBURN, LLP, 55 GRIFFIN ROAD SOUTH, BLOOMFIELD, CT, 06002

(21) Appl. No.: 09/682,564

(22) Filed: Sep. 20, 2001

Related U.S. Application Data
(60) Provisional application No. 60/233,962, filed on Sep. 20, 2000.

(51) Int. Cl. B32B 15/04; B05D 3/02

(52) U.S. Cl. 428/457; 428/411.1; 427/388.1; 427/388.4

(57) ABSTRACT

A method for enhancing the corrosion resistance of a metal article comprises coating a metal article with poly(arylene ether) in a carrier, and evaporating the carrier, wherein the poly(arylene ether) has an intrinsic viscosity of less than about 0.60 dl/g as measured in chloroform at 25 ° C. The coated metal articles find utility in automobiles, ships and in electronic media devices.

### CROSS REFERENCE TO RELATED APPLICATIONS

This application claims the benefit of U.S. Provisional Application Serial No. 60/233,962, filed Sep. 20, 2000.

### BACKGROUND OF INVENTION

This disclosure relates to methods of forming poly(arylene ether) anti-corrosion coatings for the protection of metals and the coated articles formed thereby.

Coating of metal articles for corrosion inhibition has long been an important technological goal. Flexible thermoplastics widely used as corrosion inhibition coatings in automobiles, ships and electronics often comprise volatile corrosion inhibitors. While such thermoplastics can provide important advantages such as ease of applicability from a solution and extended shelf life, they suffer from a number of drawbacks such as low thermal stability and high moisture absorption, which serve to make corrosion inhibition temporary. A need therefore exists in the art for thermoplastics that have good adhesion to metal substrates, as well as high temperature stability, and that can withstand the rigors of adverse environmental conditions. A thermoplastic that offers corrosion inhibition under such circumstances can be used in sensitive electronic media devices and other delicate metallic articles.

### SUMMARY OF INVENTION

A method for enhancing the corrosion inhibition of a metal article comprises coating the metal article with poly(arylene ether) in a carrier, and evaporating the carrier, wherein the poly(arylene ether) has an intrinsic viscosity of less than about 0.60 dl/g as measured in chloroform at 25° C. The carrier may be any suitable liquid for dispersing the poly(arylene ether) and applying it as a coating.

### BRIEF DESCRIPTION OF DRAWINGS

The Figure shows how measurements of blister size are made after a salt fog test of a coated metal plate scribed with an ‘X’.

### DETAILED DESCRIPTION

It has been unexpectedly found that poly(arylene ether) can be used as a corrosion inhibitor to protect metal articles from adverse environmental effects especially when the article is normally prone to corrosion under potentially corrosive conditions. The poly(arylene ether) coated metal article may be subsequently coated with other desirable coatings such as, for example, paint for decorative purposes. In particular it has been discovered that a metal article coated with poly(arylene ether) suffers less corrosion damage compared to similar metal articles that do not have the poly(arylene ether) coating. Thus a poly(arylene ether) coating can be effectively used to reduce blistering due to corrosion on the surface of a metal article by greater than or equal to about 20 percent, preferably greater than or equal to about 30 percent, more preferably greater than or equal to about 40 percent and most preferably greater than or equal to about 60 percent compared to a metal article that does not have a poly (arylene ether) coating.

Poly(arylene ether)s which can be used as corrosion inhibition coatings are known polymers comprising a plurality of structural units of the formula (1):

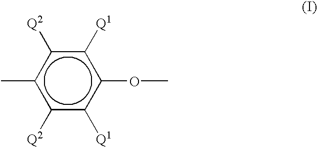

wherein for each structural unit, each Q¹ is independently halogen, primary or secondary lower alkyl (e.g., alkyl containing up to 7 carbon atoms), phenyl, haloalkyl, aminoalkyl, hydrocarbonoxy, halohydrocarbonoxy, wherein at least two carbon atoms separate the halogen and oxygen atoms, or the like; and each Q² is independently hydrogen, halogen, primary or secondary lower alkyl, phenyl, haloalkyl, hydrocarbonoxy, halohydrocarbonoxy, wherein at least two carbon atoms separate the halogen and oxygen atoms, or the like. Preferably, each Q¹ is alkyl or phenyl, especially C alkyl, and each Q² is hydrogen.

Poly(arylene ether)s are typically prepared by the oxidative coupling of at least one monohydroxyaromatic compound such as 2,6-xylenol or 2,3,6-trimethylphenol. Catalyst systems are generally employed for such coupling; they typically contain at least one heavy metal compound such as a copper, manganese or cobalt compound, usually in combination with various other materials. Poly(arylene ether)s which can be used in corrosion resistant coatings generally have a number average molecular weight of about 2,500-40,000 atomic mass units (amu) and a weight average molecular weight of about 3,500-80,000 amu, as determined by gel permeation chromatography. The poly(arylene ether) may have an intrinsic viscosity greater than about 0.05, preferably greater than or equal to about 0.06 deciliters per gram (dl/g) as measured in chloroform at 25° C. The desirable intrinsic viscosity is less than or equal to about 0.6, preferably less than or equal to about 0.3 dl/g, more preferably less than or equal to about 0.2 dl/g, and most preferably less than or equal to about 0.15 dl/g, as measured in chloroform at 25° C. It is also possible to utilize a high intrinsic viscosity poly(arylene ether) and a low intrinsic viscosity poly(arylene ether) in combination, as long as the intrinsic viscosity of the mixture is less than about 0.6 dl/g as measured in chloroform at 25° C. Determining an exact ratio, when two intrinsic viscosities are used, will depend somewhat on the exact intrinsic viscosities of the poly(arylene ether) used and the ultimate physical properties that are desired.

Particularly useful poly(arylene ether)s for many purposes are those that comprise molecules having at least one aminoalkyl-containing end group. The aminoalkyl radical is typically located in an ortho position to the hydroxy group. Products containing such end groups may be obtained by incorporating an appropriate primary or secondary monoamine such as di-n-butylamine or dimethylamine as one of the constituents of the oxidative coupling reaction mixture. Also frequently present are 4-hydroxybiphenyl end groups, typically obtained from reaction mixtures in which the by-product diphenoquinone is present, especially in a copper-halide-secondary or tertiary amine system. A substantial proportion of the polymer molecules, typically constituting as much as about 90% by weight of the polymer, may contain at least one of said aminoalkyl-containing and 4-hydroxybiphenyl end groups.

Copolymers of poly(arylene ether)s can also be used in corrosion inhibition coatings. Suitable copolymers include random copolymers which comprise 2,6-dimethyl-1,4-phenylene ether units in combination with (for example) 2,3,6-trimethyl-1,4-phenylene ether units. Also included are poly(arylene ether) copolymers wherein poly(arylene ether) is reacted or grafted with other vinyl monomers or polymers, elastomers, coupling agents such as low molecular weight polycarbonates, quinones, heterocycles and formals. The coupling agents typically undergo reaction in known manner with the hydroxy groups of poly(arylene ether) chains. Typically, carboxy-functionalized poly(arylene ether), such as the fumaric acid-grafted materials disclosed in U.S. Pat. No. 4,888,397, which is incorporated herein by reference, can be employed. It is also possible to use a blend of poly(arylene ether) with block, graft or random copolymers having poly(arylene ether) as one of their substituents.

Poly(arylene ether)s having impact modifiers may also be used as corrosion inhibition coatings. Suitable impact modifiers include natural and synthetic elastomeric polymers, typically derived from such monomers as olefins (e.g., ethylene, propylene, 1 -butene and 4-methyl-1-pentene), alkenylaromatic monomers (e.g., styrene and α-methylstyrene), conjugated dienes (e.g., butadiene, isoprene and chloroprene), and vinylic carboxylic acids and their derivatives (e.g., vinyl acetate, acrylic acid, alkylacrylic acids, ethyl acrylate, methyl methacrylate and acrylonitrile). They include homopolymers and random, block, radial block, graft and core-shell copolymers as well as combinations thereof.

A particularly useful class of impact modifiers comprises the AB (diblock) and ABA (triblock) copolymers and core-shell graft copolymers of alkenylaromatic and diene compounds, especially those comprising styrene and either butadiene or isoprene blocks. The conjugated diene blocks may be partially or entirely hydrogenated, whereupon they may be represented as ethylene-propylene blocks and the like and have properties similar to those of olefin block copolymers. Examples of triblock copolymers of this type are polystyrene-polybutadiene-polystyrene (SBS), hydrogenated polystyrene-polybutadiene-polystyrene (SEBS), polystyrene-polysoprene-polystyrene-polybutadiene-polystyrene (SIS), poly(α-methylstyrene)-polybutadiene-poly(α-methylstyrene and poly(α-methylstyrene)-polyisoprene-poly(α-methylstyrene). Particularly preferred triblock copolymers are available commercially as Cariflex ®, Kraton D ®, and Kraton G ® from Shell. The poly(arylene ether) corrosion inhibitors can also contain inhibition composition impact modifiers compatible with either or both of the poly(arylene ether) and the graft copolymer.

Also suitable as impact modifiers are core-shell type graft copolymers and ionomer resins, which may be wholly or partially neutralized with metal ions. In general, the core-shell type graft copolymers have a predominantly conjugated diene or crosslinked acrylate rubbery core and one or more shells polymerized thereon and derived from monoalkenylaromatic and/or acrylic monomers alone or in combination with other vinyl monomers. Other impact modifiers include the above-described types containing units having polar groups or active functional groups, as well as miscellaneous polymers such as Thiokol rubber, polysulfide rubber, polyurethane rubber, polyether rubber (e.g., polypropylene oxide), epichlorohydrin rubber, ethylene-propylene rubber, thermoplastic polyester elastomers, thermoplastic ether-ester elastomers, and the like, as well as mixtures comprising any one of the foregoing.

The poly(arylene ether) compositions may also contain conventional ingredients such as fillers, flame retardants, pigments, dyes, stabilizers, anti-static agents, anti-oxidants, anti-ozonants, crystallization aids, mold release agents and the like, as well as mixtures comprising any one of the foregoing.

The proportions of poly(arylene ether), graft copolymer and other resinous materials such as impact modifier (if present) may be widely varied to provide compositions having the desired properties by one of ordinary skill in the art. Most often, the poly(arylene ether) is present in an amount greater than or equal to about 5, preferably greater than or equal to about 10, more preferably greater than or equal to about 15 wt% based on the total corrosion inhibition composition after application, when substantially all of the carrier has evaporated. It is generally desirable to have the poly(arylene ether) less than or equal to 95, preferably less than or equal to 90, more preferably less than or about 85 wt% of the total corrosion inhibition coating composition after application to a metal article, when substantially all of the carrier has evaporated.

The poly(arylene ether) is typically dispersed in a carrier for use in forming a corrosion inhibition coating. The carrier may be any liquid suitable for dispersing the poly(arylene ether) and applying it as a coating. It is preferable that the carrier be a solvent that can dissolve poly(arylene ether), for example toluene. Common solvents known in the art such as, but not limited to, alcohols, acetone, methyl ethyl ketone, chlorobenzene, N,N-dimethylformamide, and the like, or mixtures comprising any one of the foregoing may be used as carriers. The poly(arylene ether)-carrier combination is applied to metal articles which need to be inhibited against corrosion. Typically, the carrier evaporates after application to the metal article and therefore does not constitute any substantial part of the corrosion inhibition coating. Alternately the evaporation of the carrier from the coated metal article may be assisted or accelerated by using thermal energy (e.g. heating in an oven) or radiation (e.g. infrared, microwave, radio frequency) and the like. The carrier is generally present in an amount greater than or equal to about 80, preferably greater than or equal to about 85, more preferably greater than or equal to about 90 wt% of the poly(aryiene ether)-carrier combination.

The poly(arylene ether)-carrier combination may be used to apply a corrosion inhibition coating to a metal surface either through spray painting, dip coating, bar coating, hand painting, electrostatic spray painting, and other methods commonly used in the art. The metal surface may be cleaned, degreased, and painted with a primer prior to application of the poly(arylene ether) corrosion inhibition coating if desirable. The coated metal article may be baked to a temperature greater than the glass transition temperature of the poly(arylene ether) in order to enhance the adhesion of the polyphenylene ether coating to the metal article and the corrosion protection of the metal article. The thickness of the corrosion inhibition coating comprising poly(arylene ether) may be greater than or equal to about 0.01 micron, preferably greater than or equal to about 0.1 micron, and more preferably greater than or equal to about 1 micron. It is generally desirable to have the corrosion inhibition coating thickness less than or equal to 10,000 microns, preferably less than or equal to about 9,500 microns, and more preferably less than or equal to about 9,000 microns.

In a preferred embodiment, in one method of practicing the invention an article is coated using a bar coater with poly(arylene ether) in toluene. The coating is dried, and a polyurethane clear coat is then applied to the metal article. The polyurethane coating is allowed to dry and cure for about six days under ambient conditions. Such a coating has been found to be very effective in inhibiting corrosion and finds utility in electronic applications, protection of sea-faring vessels such as ships and boats, protection of automobiles, and the like.

The invention is further illustrated by the following non-limiting example.

Cold rolled steel (CRS) plates (1.5865 cm ×10.16 cm ×15.24) cm were first mechanically degreased using methyl ethyl ketone. The plates were coated with 10 wt% of poly(arylene ether) in toluene. The poly(arylene ether) has an intrinsic viscosity of either 0.4 dl/g or 0.12 dl/g when measured in chloroform at 25° C. The coating was applied using a #12 barcoater. Some of the plates were not coated with the poly (arylene ether) and these were used as controls. The coated CRS plates were allowed to dry under ambient conditions for one hour and then baked in an oven set at 215° C. for 15 minutes. The CRS plates were subsequently coated with a polyurethane clearcoat comprising a polyol resin (Jonacryl 910 from SC Johnson Polymer) at about 78.8 wt% and an isocyanate (Desmodur N 3390 available from Bayer) at about 21.2 wt%. The mixture of polyol and isocyanate comprise about 60 wt% of the clearcoat, with the remainder being comprised by methylisobutylketone (MIBK) solvent at about 40 wt%. The polyurethane clearcoat was applied using a #80 wire barcoater. The coating was allowed to dry and cure at ambient conditions for 6 days. The thickness of the polyurethane coating was less than about 40 micrometers. The CRS plate was then masked with tape on the back and for about 0.5 cm around the edges.

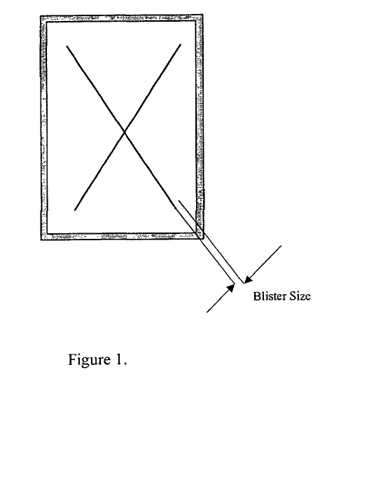

The efficacy of coating in providing corrosion inhibition was measured by a blister test wherein an ‘X’ is scribed through the coating on the coated metal article and the metal article is subjected to a salt fog test as prescribed by ASTM B117. The damage to the coating is the average, linear distance that the coating appears to blister from the metal plate as measured from the central ‘X’ scribe line as shown in FIG. 1.

The CRS plate was then masked with tape on the back and for about 0.5 cm around the edges. The degree of blistering was noted at periodic intervals of 24, 72 and 168 hours as shown in the Table 1 below, which contains the results for selected samples.

As can be seen in Table 1, samples coated with the poly(arylene ether) corrosion inhibition coating show much less blistering compared to those not coated. In addition it can be seen that the steel plate coated with the poly(arylene ether) having a lower intrinsic viscosity (0.12 dl/g) showed better corrosion inhibition than the steel plate coated with the higher intrinsic viscosity (0.41 dl/g).

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

TABLE 1

| | | | Initial | | | |
|---|---|---|---|---|---|---|
| | | | Adhesion | | | |
| | | Urethane | ASTM | Salt Spray Test Results | | |
| Sample # | PPE, IV | Clearcoat | D3359 | 24 hours | 72 hours | 168 hours |
| 01 | 0.41 | yes | (NT)** | blisters- | blisters- | blisters- |
| | | | | 3 mm | 6 mm | 10 mm |
| 02 | 0.41 | yes | NT | blisters - | blisters- | blisters- |
| | | | | 3 mm | 6 mm | 10 mm |
| 03 | 0.41 | yes | NT | blisters - | blisters- | blisters- |
| | | | | 3 mm | 6 mm | 10 mm |
| 04 | 0.41 | yes | 100% | blisters - | blisters- | blisters- |
| | | | (PASS) | 3 mm | 6 mm | 10 mm |
| 05 | 0.12 | yes | NT | blisters - | blisters- | blisters- |
| | | | | 2 mm | 4 mm | 8 mm |
| 06 | 0.12 | yes | NT | blisters - | blisters- | blisters- |
| | | | | 2 mm | 4 mm | 8 mm |
| 07 | 0.12 | yes | NT | blisters - | blisters- | blisters- |
| | | | | 2 mm | 4 mm | 8 mm |
| 08 | 0.12 | yes | 50% (FAIL) | blisters - | blisters- | blisters- |
| | | | | 2 mm | 4 mm | 8 mm |
| 09* | None | yes | NT | blisters - | blisters- | blisters- |
| | | | | 5 mm | 10 mm | 15 mm |
| 10* | None | yes | NT | blisters - | blisters- | blisters- |
| | | | | 5 mm | 10 mm | 15 mm |
| 11* | None | yes | 20% (FAIL) | blisters - | blisters- | blisters- |
| | | | | 5 mm | 10 mm | 15 mm |

| | | | | |
|---|---|---|---|---|
| 12* | None | no | NT | Complete corrosion |

*Comparative examples; **Intrinsic Viscosity measured in chloroform at 25 C.
***NT - not tested.

1. A method for enhancing the corrosion resistance of a metal article comprising:
coating a metal article with poly(arylene ether) in a carrier;
and evaporating the carrier.

2. The method of claim 1, wherein the poly(arylene ether) has an intrinsic viscosity of less than about 0.60 dl/g as measured in chloroform at 25° C.

3. The method of claim 1, wherein the poly(arylene ether) has an intrinsic viscosity of less than about 0.30 dl/g as measured in chloroform at 25° C.

4. The method of claim 1, wherein the poly(arylene ether) has an intrinsic viscosity of less than about 0.20 dl/g as measured in chloroform at 25° C.

5. The method of claim 1, wherein poly(arylene ether) has the general formula represented by: 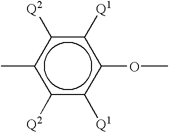
wherein Q¹ is selected from the group consisting of halogen, primary or secondary lower alkyl, phenyl, haloalkyl, aminoalkyl, hydrocarbonoxy or halohydrocarbonoxy and Q² is independently selected from the group consisting of hydrogen, halogen, primary or secondary lower alkyl, phenyl, haloalkyl, hydrocarbonoxy or halohydrocarbonoxy.

6. The method of claim 5, wherein Q¹ is alkyl or phenyl and Q² is hydrogen.

7. The method of claim 1, wherein the poly(arylene ether) comprises endgroups selected from the group consisting of aminoalkyl-containing end groups or 4-hydroxbiphenyl end groups, or mixtures comprising any one of the foregoing endgroups.

8. The method of claim 1, wherein the poly(arylene ether) is a random, graft or block copolymer.

9. The method of claim 1, wherein the poly(arylene ether) further comprises an impact modifier.

10. The method of claim 1, further comprising heat treating the metal article above the glass transition temperature of the poly(arylene ether) after application of the poly(arylene ether) carrier combination.

11. The method of claim 1, wherein the carrier comprises a solvent.

12. The method of claim 1, wherein the carrier comprises toluene.

13. The method of claim 1, further comprising applying a polyurethane coating to the coated metal article.

14. A coated metal article made by the method of claim 1.

15. A corrosion inhibited metal article which comprises:
a metal article; and
a coating of polyphenylene ether.

16. A metal article as in claim 1 5, wherein the corrosion inhibited metal article is heat treated above the glass transition temperature of the polyphenylene ether after the application of the coating of polyphenylene ether.

17. A metal article as in claim 1 5, wherein the corrosion inhibited metal article is heat treated above the glass transition temperature of the polyphenylene ether to enhance the adhesion of the polyphenylene ether coating to the metal article and the corrosion protection of the metal article.
